(19) United States
(12) Patent Application Publication
(10) Pub. No.: US 2025/0148725 A1
(43) Pub. Date: May 8, 2025

(54) AUTONOMOUS SYSTEM TRAINING AND TESTING

(71) Applicant: WAABI Innovation Inc., Toronto (CA)

(72) Inventors: Raquel URTASUN, Toronto (CA); Sivabalan MANIVASAGAM, Toronto (CA); Neil Clifford ISAAC, Toronto (CA)

(73) Assignee: WAABI Innovation Inc., Toronto, ON (CA)

(21) Appl. No.: 18/835,285

(22) PCT Filed: Feb. 8, 2023
(86) PCT No.: PCT/CA23/50165

§ 371 Date: Aug. 1, 2024

(51) Int. Cl. G06T 19/00; G01S 17/89; G06N 3/094; G06T 11/00

(52) U.S. Cl. CPC G06T 19/003; G01S 17/89; G06N 3/094; G06T 11/00; G06T 19/006

(57) ABSTRACT

The operations of autonomous system training and testing may include generating a digital twin of a real world scenario as a simulated environment state of a simulated environment. The operations may also include iteratively, through multiple timesteps: executing a sensor simulation model on the simulated environment state to obtain simulated sensor output, obtaining, from a virtual driver of an autonomous system, at least one actuation action that is based on the simulated sensor output, updating an autonomous system state of the autonomous system based on the at least one actuation action, modeling, using multiple actor models, multiple actors in the simulated environment according to the simulated environment state to obtain multiple actor actions, and updating the simulated environment state according to the actor actions and the autonomous system state. The operations may furthermore include evaluating the virtual driver after updating the simulated environment state.

### CROSS REFERENCE TO RELATED APPLICATIONS

This application is a non-provisional application of, and thereby claims benefit to, U.S. Patent Application Ser. No. 63/308,042 filed on Feb. 8, 2022. U.S. Patent Application Ser. No. 63/308,042 is incorporated herein by reference in its entirety.

### BACKGROUND

Autonomous system is a self-driving mode of transportation that does not require a human pilot or human driver to move in and react to the real-world environment. Rather, the autonomous system includes a virtual driver that is the decision making portion of the autonomous system. Specifically, the virtual driver controls the actuation of the autonomous system. The virtual driver is an artificial intelligence system that learns how to interact in the real world. As an artificial intelligence system, the virtual driver is trained and tested. However, because virtual driver controls a mode of transportation in the real world, the training and testing of the virtual driver should be more rigorous than other artificial intelligence systems.

### SUMMARY

In one general aspect, a method may include generating a digital twin of a real world scenario as a simulated environment state of a simulated environment. The method may also include iteratively, through multiple timesteps: executing a sensor simulation model on the simulated environment state to obtain simulated sensor output, obtaining, from a virtual driver of an autonomous system, at least one actuation action that is based on the simulated sensor output, updating an autonomous system state of the autonomous system based on the at least one actuation action, modeling, using multiple actor models, multiple actors in the simulated environment according to the simulated environment state to obtain multiple actor actions, and updating the simulated environment state according to the actor actions and the autonomous system state. The method may furthermore include evaluating the virtual driver after updating the simulated environment state.

In one general aspect, system may include a virtual driver of an autonomous system, and a computer processor executing a simulator causing the computer processor to perform operations. The operations may include generating a digital twin of a real world scenario as a simulated environment state of a simulated environment. The operations may also include iteratively, through multiple timesteps: executing a sensor simulation model on the simulated environment state to obtain simulated sensor output, obtaining, from a virtual driver of an autonomous system, at least one actuation action that is based on the simulated sensor output, updating an autonomous system state of the autonomous system based on the at least one actuation action, modeling, using multiple actor models, multiple actors in the simulated environment according to the simulated environment state to obtain multiple actor actions, and updating the simulated environment state according to the actor actions and the autonomous system state. The operations may furthermore include evaluating the virtual driver after updating the simulated environment state.

In one general aspect, non-transitory computer readable medium may include computer readable program code to perform operations. The operations may include generating a digital twin of a real world scenario as a simulated environment state of a simulated environment. The operations may also include iteratively, through multiple timesteps: executing a sensor simulation model on the simulated environment state to obtain simulated sensor output, obtaining, from a virtual driver of an autonomous system, at least one actuation action that is based on the simulated sensor output, updating an autonomous system state of the autonomous system based on the at least one actuation action, modeling, using multiple actor models, multiple actors in the simulated environment according to the simulated environment state to obtain multiple actor actions, and updating the simulated environment state according to the actor actions and the autonomous system state. The operations may furthermore include evaluating the virtual driver after updating the simulated environment state.

Other aspects of the invention will be apparent from the following description and the appended claims.

### BRIEF DESCRIPTION OF DRAWINGS

FIG. 1 shows a diagram of a system in accordance with one or more embodiments.

FIG. 2 shows a more detailed diagram of a system in accordance with one or more embodiments.

FIGS. 3, 4, 5, 6, 7, 8, and 9 show flow diagrams in accordance with one or more embodiments.

FIG. 10 shows a flowchart in accordance with one or more embodiments.

FIG. 11 shows an example of a simulator in accordance with one or more embodiments.

FIGS. 12A and 12B show examples in accordance with one or more embodiments.

FIG. 13 shows an example of various simulation scenarios in accordance with one or more embodiments.

FIGS. 14A, 14B, and 14C show an example of training in accordance with one or more embodiments.

FIGS. 15A, 15B, and 15C show an example of the simulator performing mixed reality simulation by modifying an actor behavior from a real world.

FIGS. 16A and 16B show a computing system in accordance with one or more embodiments of the invention.

Like elements in the various figures are denoted by like reference numerals for consistency.

### DETAILED DESCRIPTION

In general, embodiments are directed to the training and testing of autonomous systems. An autonomous system is a self-driving mode of transportation that does not require a human pilot or human driver to move and react to the real-world environment. Rather, the autonomous system includes a virtual driver that is the decision making portion of the autonomous system. The virtual driver is an artificial intelligence system that learns how to interact in the real world. The autonomous system may be completely autonomous or semi-autonomous. As a mode of transportation, the autonomous system is contained in a housing configured to move through a real-world environment. Examples of autonomous systems include self-driving vehicles (e.g., self-driving trucks and cars), drones, airplanes, robots, etc. The virtual driver is the software that makes decisions and causes the autonomous system to interact with the real-world including moving, signaling, and stopping or maintaining a current state.

The real world environment is the portion of the real world through which the autonomous system, when trained, is designed to move. Thus, the real world environment may include interactions with concrete and land, people, animals, other autonomous systems, and human driven systems, construction, and other objects as the autonomous system moves from an origin to a destination. In order to interact with the real-world environment, the autonomous system includes various types of sensors, such as LIDAR sensors amongst other types, which are used to obtain measurements of the real-world environment and cameras that capture images from the real world environment.

The testing and training of virtual driver of the autonomous systems in the real-world environment is unsafe because of the accidents that an untrained virtual driver can cause. Further, training a virtual driver using only real-world logged data does not capture rare events that may occur.

In order to test and train a virtual driver, embodiments include a simulator that models a variety of scenarios. The modeling by the simulator includes autonomous system interaction in the simulated environment and other actors' reaction in the simulated environment. Thus, the simulator does not merely replay logged data of the real world environment. Further, the simulator further adapts to decisions of the autonomous system by building scenarios based on the autonomous system

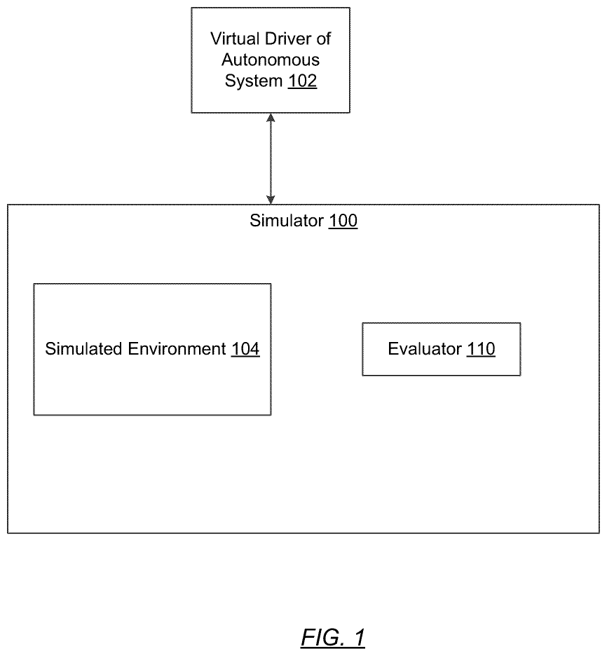

Turning now to the Figures, as shown in FIG. 1, a simulator (100) is configured to train and test a virtual driver of an autonomous system (102). For example, the simulator may be a unified, modular, mixed-reality, closed-loop simulator for autonomous systems. The simulator (100) is a configurable simulation framework that enables not only evaluation of different autonomy components in isolation, but also as a complete system in a closed-loop manner. The simulator reconstructs “digital twins” of real world scenarios automatically, enabling accurate evaluation of the virtual driver at scale. The simulator (100) may also be configured to perform mixed-reality simulation that combines real world data and simulated data to create diverse and realistic evaluation variations to provide insight into the virtual driver's performance. The mixed reality closed-loop simulation allows the simulator (100) to analyze the virtual driver's action on counterfactual “what-if” scenarios that did not occur in the real-world. The simulator (100) further includes functionality to simulate and train on rare yet safety-critical scenarios with respect to the entire autonomous system and closed-loop training to enable automatic and scalable improvement of autonomy.

The simulator (100) creates the simulated environment (104). The simulated environment (104) is a simulation of a real-world environment, which may or may not be in actual existence, in which the autonomous system is designed to move. As such, the simulated environment (104) includes a simulation of the objects (i.e., simulated objects) and background in the real world, including the natural objects, construction, buildings and roads, obstacles, as well as other autonomous and non-autonomous objects. The simulated environment simulates the environmental conditions within which the autonomous system may be deployed. Additionally, the simulated environment (104) may be configured to simulate various weather conditions that may affect the inputs to the autonomous systems. The simulated objects may include both stationary and non-stationary objects. Non-stationary objects are actors in the real-world environment.

The simulator (100) also includes an evaluator (110). The evaluator is configured to train and test the virtual driver (102) by creating various scenarios the simulated environment. Each scenario is a configuration of the simulated environment including, but not limited to, static portions, movement of simulated objects, actions of the simulated objects with each other and reactions to actions taken by the autonomous system and simulated objects. The evaluator (110) is further configured to evaluate the performance of the virtual driver using a variety of metrics.

In one or more embodiments, the evaluator (110) is adversarial to the virtual driver of the autonomous system (102). By observing how the virtual driver (102) drives in various scenarios, the evaluator (110) learns where the virtual driver (102) might fail evaluation metrics, and then creates difficult scenarios based on what the evaluator has learned. Then, the scenarios can be used to test and/or train the virtual driver. During training, the evaluator (110) sends metric information to the virtual driver (102), and the virtual driver uses this information to update the virtual driver's parameters and handle the scenarios better. The more that the evaluator (110) evaluates the virtual driver operating in the simulated environment, the better the evaluator is at finding deficiencies or difficulties or failures of the virtual driver. Thus, the goal of the evaluator (110) is to identify the scenarios in which the virtual driver of the autonomous system (102) may perform sub-optimally and then train and test for those scenarios.

As described above, the evaluator (110) assesses the performance of the virtual driver throughout the performance of the scenario. Assessing the performance may include applying rules. For example, the rules may be that the automated system does not collide with any other actor, compliance with safety and comfort standards (e.g., passengers not experiencing more than a certain acceleration force within the vehicle), the automated system not deviating from executed trajectory), or other rule. Each rule may be associated with the metric information that relates a degree of breaking the rule with a corresponding score. The evaluator (110) may be implemented as a data-driven neural network learns to distinguish between good and bad driving behavior. The various metrics of the evaluation system may be leveraged to determine whether the automated system satisfies the requirements of success criterion for a particular scenario. Further, in addition to system level performance, for modular based virtual drivers, the evaluator may also evaluate individual modules such as segmentation or prediction performance for actors in the scene with respect to the ground truth recorded in the simulator.

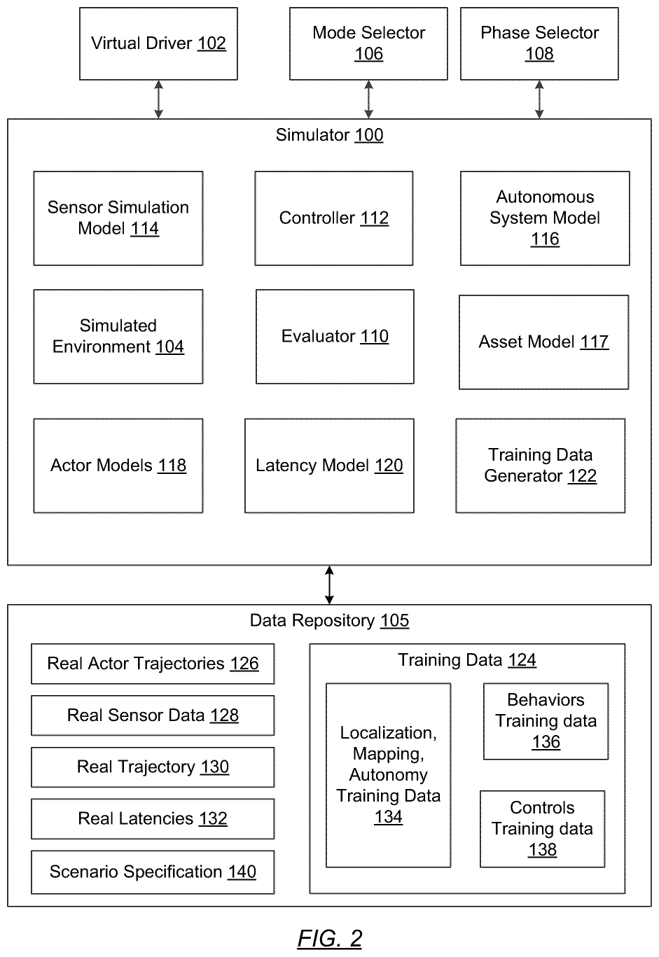

FIG. 2 shows a more detailed diagram of the system in accordance with one or more embodiments. As shown in FIG. 2, the system includes the simulator (100) connected to a data repository (105). The simulator is configured to operate in multiple phases as selected by the phase selector (108) and modes as selected by a mode selector (106). The phase selector (108) and mode selector (106) may be a graphical user interface or application programming interface component that is configured to receive a selection of phase and mode, respectively. The selected phase and mode define the configuration of the simulator (100). Namely, the selected phase and mode define which system components communicate and the operations of the system components.

The phase may be selected using a phase selector (108). The phase (108) may be training phase or testing phase. In the training phase, the evaluator (110) provides metric information to the virtual driver (102), which uses the metric information to update the virtual driver (102). The evaluator (110) may further use the metric information to further train the virtual driver (102) by generating scenarios for the virtual driver. In the testing phase, the evaluator (110) does not provide the metric information to the virtual driver. In the testing phase, the evaluator (110) uses the metric information to assess the virtual driver and to develop scenarios for the virtual driver (102).

The mode may be selected by the mode selector (106). The mode defines the degree to which real-world data is used, whether noise is injected into simulated data, degree of perturbations of real world data, and whether the scenarios are designed to be adversarial. Example modes include open loop simulation mode, closed loop simulation mode, single module closed loop simulation mode, fuzzy mode, adversarial mode, and fuzzy mode. In an open loop simulation mode, the virtual driver is evaluated with real world data. In a single module closed loop simulation mode, a single module of the virtual driver is tested. An example of a single module closed loop simulation mode is a localizer closed loop simulation mode in which the simulator evaluates how the localizer estimated pose drifts over time as the scenario progresses in simulation. In a training data simulation mode, simulator is used to generate training data. In a closed loop evaluation mode, the virtual driver and simulation system are executed together to evaluate system performance. In the adversarial mode, the actors are modified to perform adversarial. In the fuzzy mode, noise is injected into the scenario (e.g., to replicate signal processing noise and other types of noise). Other modes may exist without departing from the scope of the system.

Further, as shown in FIG. 2, the simulator (100) includes the controller (112) that includes functionality to configure the various components of the simulator (100) according to the selected mode and phase. Namely, the controller (112) may modify the configuration of the each of the components of the simulator based on configuration parameters of the simulator (100). As described above in reference to FIG. 1, the simulator (100) includes the evaluator (110) and the simulated environment (104). The various components of the simulator (100) may also include an autonomous system model (116), sensor simulation models (114), asset models (117), actor models (118), latency models (120), a training data generator (122), the simulated environment (104). Each of these components is described below.

The autonomous system model (116) is a detailed model of the autonomous system in which the virtual driver will execute. The autonomous system model (116) includes model, geometry, physical parameters (e.g., mass distribution, points of significance), engine parameters, sensor locations and type, firing pattern of the sensors, information about the hardware on which the virtual driver executes (e.g., processor power, amount of memory, and other hardware information), and other information about the autonomous system. The various parameters of the autonomous system model may be configurable by the user or another system.

For example, if the autonomous system is a motor vehicle, the modeling and dynamics may include the type of vehicle (e.g., car, truck), make and model, geometry, physical parameters such as the mass distribution, axle positions, type and performance of engine, etc. The vehicle model may also include information about the sensors on the vehicle (e.g., camera, LiDAR, etc.), the sensors' relative firing synchronization pattern, and the sensors' calibrated extrinsics (e.g., position and orientation) and intrinsics (e.g., focal length). The vehicle model also defines the onboard computer hardware, sensor drivers, controllers, and the autonomy software release under test.

The vehicle dynamics simulation takes the actuation actions of the virtual driver (e.g., steering angle, desired acceleration) and enacts the actuation actions on the autonomous system in the simulated environment to update the simulated environment and the state of the autonomous system. To update the state, a kinematic motion model may be used, or a dynamics motion model that accounts for the forces applied to the vehicle may be used to determine the state. Within the simulator, with access to real log scenarios with ground truth actuations and vehicle states at each time step, embodiments may also optimize analytical vehicle model parameters or learn parameters of a neural network that infers the new state of the autonomous system given the virtual driver outputs.

In one or more embodiments, the sensor simulation models (114) models, in the simulated environment, active and passive sensor inputs. Passive sensor inputs capture the visual appearance of the simulated environment including stationary and nonstationary simulated objects from the perspective of one or more cameras based on the simulated position of the camera(s) within the simulated environment. Example of passive sensor inputs include inertial measurement unit (IMU) and thermal Active sensor inputs are inputs to the virtual driver of the autonomous system from the active sensors, such as LiDAR, RADAR, global positioning system (GPS), ultrasound, etc. Namely, the active sensor inputs include the measurements taken by the sensors, the measurements being simulated based on the simulated environment based on the simulated position of the sensor(s) within the simulated environment. By way of an example, the active sensor measurements may be measurements that a LIDAR sensor would make of the simulated environment over time and in relation to the movement of the autonomous system.

The sensor simulation models (114) are configured to simulates the sensor observations of the surrounding scene in the simulated environment (104) at each time step according to the sensor configuration on the vehicle platform. When the simulated environment directly represents the real world environment, without modification, the sensor output may be directly fed into the virtual driver. For light-based sensors, the sensor model simulate light as rays that interact with objects in the scene to generate the sensor data. Depending on the asset representation (e.g., of stationary and nonstationary objects), embodiments may use graphics-based rendering for assets with textured meshes, neural rendering, or a combination of multiple rendering schemes. Leveraging multiple rendering schemes enables customizable world building with improved realism. Because assets are compositional in 3D and support a standard interface of render commands, different asset representations may be composed in a seamless manner to generate the final sensor data. Additionally, for scenarios that replay what happened in a real world and use the same autonomous system as in the real world, the original sensor observations may be replayed at each time step.

Asset models (117) includes multiple models, each model modeling a particular type of individual assets in the real world. The assets may include inanimate objects such as construction barriers or traffic signs, parked cars, and background (e.g., vegetation or sky). Each of the entities in a scenario may correspond to an individual asset. As such, an asset model, or instance of a type of asset model, may exist for each of the entities or assets in the scenario. The assets can be composed together to form the three dimensional simulated environment. An asset model provides all the information needed by the simulator to simulate the asset. The asset model provides the information used by the simulator to represent and simulate the asset in the simulated environment. For example, an asset model may include geometry and bounding volume, the asset's interaction with light at various wavelengths of interest (e.g., visible for camera, infrared for LiDAR, microwave for RADAR), animation information describing deformation (e.g. rigging) or lighting changes (e.g., turn signals), material information such as friction for different surfaces, and metadata such as the asset's semantic class and key points of interest. Certain components of the asset may have different instantiations. For example, similar to rendering engines, an asset geometry may be defined in many ways, such as a mesh, voxels, point clouds, an analytical signed-distance function, or neural network. Asset models may be created either by artists, or reconstructed from real world sensor data, or optimized by an algorithm to be adversarial.

Closely related to, and possibly considered part of the set of asset models (117) are actor models (118). An actor model represents an actor in a scenario. An actor is a sentient being that has an independent decision making process. Namely, in a real world, the actor may be animate being (e.g., person or animal) that makes a decision based on an environment. The actor makes active movement rather than or in addition to passive movement. An actor model, or an instance of an actor model may exist for each actor in a scenario. The actor model is a model of the actor. If the actor is in a mode of transportation, then the actor model includes the model of transportation in which the actor is located. For example, actor models may represent pedestrians, children, vehicles being driven by drivers, pets, bicycles, and other types of actors.

The actor model leverages the scenario specification and assets to control all actors in the scene and their actions at each time step. The actor's behavior is modeled in a region of interest centered around the autonomous system. Depending on the scenario specification, the actor simulation will control the actors in the simulation to achieve the desired behavior. Actors can be controlled in various ways. One option is to leverage heuristic actor models, such as intelligent-driver model (IDM) that try to maintain a certain relative distance or time-to-collision (TTC) from a lead actor, or heuristic-derived lane-change actor models. Another is to directly replay actor trajectories from a real log, or to control the actor(s) with a data-driven traffic model. Through the configurable design, embodiments may can mix and match different subsets of actors to be controlled by different behavior models. For example, far-away actors that initially may not interact with the autonomous system and can follow a real log trajectory, but when near the vicinity of the autonomous system may switch to a data-driven actor model. In another example, actors may be controlled by a heuristic or data-driven actor model that still conforms to the high-level route in a real-log. This mixed-reality simulation provides control and realism.

Further, actor models may be configured to be in cooperative or adversarial model. In cooperative mode, the actor model models actors to act rationally in response to the state of the simulated environment. In adversarial mode, the actor model may model actors acting irrationally, such as exhibiting road rage and bad driving.

The latency model (120) represents timing latency that occurs when the autonomous system is in the real world environment. Several sources of timing latency may exist. For example, a latency may exist from the time that an event occurs to the sensors detecting the sensor information from the event and sending the sensor information to the virtual driver. Another latency may exist based on the difference between the computing hardware executing the virtual driver in the simulated environment as compared to the computing hardware of the virtual driver. Further, another timing latency may exist between the time that the virtual driver transmits an actuation signal to the autonomous system changing (e.g., direction or speed) based on the actuation signal. The latency model (120) models the various sources of timing latency.

Stated another way, in the real world, safety-critical decisions in the real world may involve fractions of a second affecting response time. To ensure replication of real-world behavior of the autonomous system, an important part of the simulation system is simulating the exact timings and latency of different components of the onboard system. One option to perform this is to run the autonomy system on the exact same onboard computer hardware as in the real world (i.e., hardware-in-the-loop (HIL)) simulation. However, using the same on-board computer may be expensive and infeasible for running simulations at scale. To enable scalable evaluation without strict requirement on exact hardware, the latencies and timings of the different components of autonomy and sensor modules are modeled while running on different computer hardware. The latency model may be replay latencies recorded from previously collected real world data or have a data-driven neural network that infers latencies at each time step to match the HIL simulation setup.

The training data generator (122) is configured to generate training data (124) (described below). For example, the training data generator (122) may modify real-world scenarios to create new scenarios. The modification of real-world scenarios is referred to as mixed-reality. For example, mixed-reality simulation may involve adding in new actors with novel behaviors, changing the behavior of one or more of the actors from the real-world, and modifying the sensor data in that region while keeping the remainder of the sensor data the same as the original log. In some cases, the training data generator (122) converts a benign scenario into a safety-critical scenario.

The simulator is connected to a data repository (105). The data repository (105) is any type of storage unit or device that is configured to store data. The data repository (105) includes data gathered from the real world. For example, the data gathered from the real world include real actor trajectories (126), real sensor data (128), real trajectory of the system capturing the real world (130), and real latencies (132). Each of the real actor trajectories (126), real sensor data (128), real trajectory of the system capturing the real world (130), and real latencies (132) is data captured by or calculated directly from one or more sensors from the real world (e.g., in a real world log). In other words, the data gathered from the real-world are actual events that happened in real life. For example, in the case that the autonomous system is a vehicle, the real world data may be captured by a vehicle driving in the real world with sensor equipment.

The data repository (105) also includes functionality to store training data (124). Training data (124) is data that is replicates real-world data if a scenario were to happen in the real world. Thus, training data (124) is generated data that is used to simulate real world events. Training data (124) includes localization, mapping, and autonomy training data (134), behavior training data (136) simulating behavior of actors, and controls training data (138) simulating controls of the autonomous system.

Further, the data repository (105) includes functionality to store one or more scenario specifications (140). A scenario specification (140) specifies a scenario and evaluation setting for testing or training the autonomous system. For example, the scenario specification (140) may describe the initial state of the scene, such as the current state of autonomous system (e.g., the full 6D pose, velocity and acceleration), the map information specifying the road layout, and the scene layout specifying the initial state of all the dynamic actors and objects in the scenario. The scenario specification may also include dynamic actor information describing how the dynamic actors in the scenario should evolve over time which are inputs to the actor models. The dynamic actor information may include route information for the actors, desired behaviors or aggressiveness. The scenario specification (140) may be specified by a user, programmatically generated using a domain-specification-language (DSL), procedurally generated with heuristics from a data-driven algorithm, or adversarial. The scenario specification (140) can also be conditioned on data collected from a real world log, such as a taking place on a specific real world map, or having a subset of actors defined by their original locations and trajectories.

The interfaces between virtual driver and the simulator match the interfaces between the virtual driver and the autonomous system in the real world. For example, the sensor simulation model (114) and the virtual driver matches the virtual driver interacting with the sensors in the real world. The virtual driver is the actual autonomy software that executes on the autonomous system. The simulated sensor data that is output by the sensor simulation model (114) may be in or converted to the exact message format that the virtual driver takes as input as if the virtual driver were in the real world, and the virtual driver can then run as a black box virtual driver with the simulated latencies incorporated for components that run sequentially. The virtual driver then outputs the exact same control representation that it uses to interface with the low-level controller on the real autonomous system. The autonomous system model (116) will then update the state of the autonomous system in the simulated environment. Thus, the various simulation models of the simulator (100) run in parallel asynchronously at their own frequencies to match the real world setting.

While FIGS. 1 and 2 show a configuration of components, other configurations may be used without departing from the scope of the invention. For example, various components may be combined to create a single component. As another example, the functionality performed by a single component may be performed by two or more components.

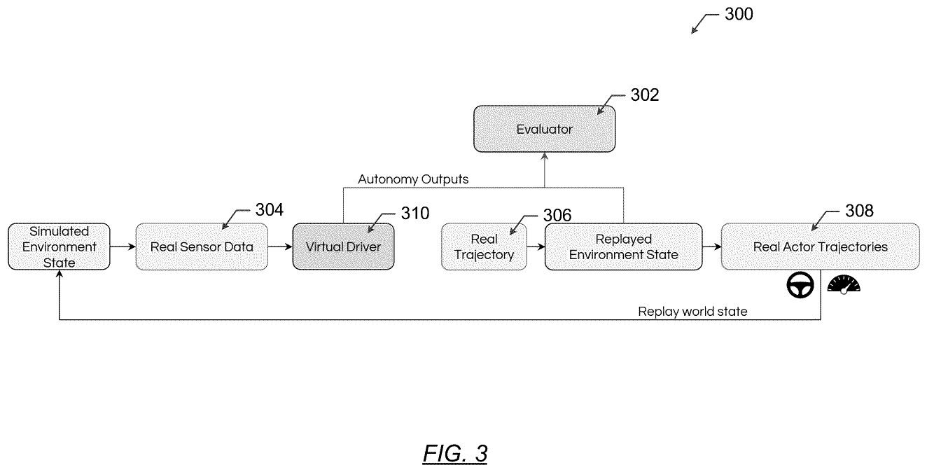

FIGS. 3-9 show examples of different modes of the simulator in accordance with one or more embodiments. The various components shown in FIGS. 3-9 may be performed using the components of FIGS. 1 and 2. FIG. 3 shows an example of open-loop evaluation that may be performed by the simulator. Open loop evaluation is “log-replay,” where a previously recorded log (e.g., having real sensor data (304), real trajectory of the autonomous system (306), and real actor trajectories (308)) collected by the same autonomous system platform in the real world is played back in simulation with the same exact messages and timings, but with a different virtual driver (310) to evaluate change in behavior. Each of the models (i.e., actor simulation, sensor simulation, latency model, vehicle model) of FIG. 2 can replay the respective messages in simulation and the evaluator (302) can monitor the autonomy's outputs at each time step. As shown in FIG. 3, the virtual driver does not interact with the simulator or act on its outputs. Rather, the virtual driver simply generates outputs given the replayed inputs.

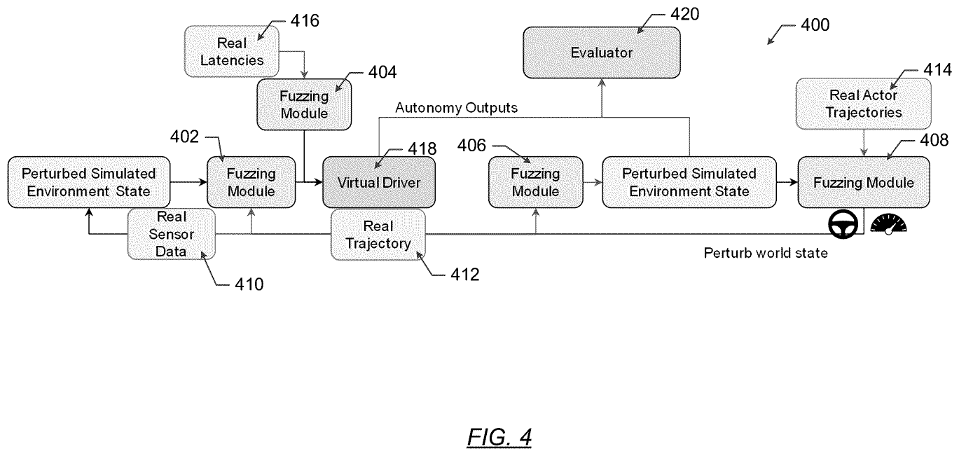

FIG. 4 shows an example of the open-loop evaluation with the simulator performing fuzz testing mode (400). In other words, fuzzy modules (402, 404, 406, and 408) add perturbations to real sensor data (410), real trajectory of the autonomous system (412), and real actor trajectories (414), and real latencies (416). The simulator can also perform mixed-reality in this setting and perform “fuzz-testing”, where the real world input messages are perturbed with realistic noise. Thus, changes in performance of the virtual driver (418) can be analyzed by the evaluator (420) to determine how well the virtual driver (418) reacts to noise. For example, the simulator can inject noise into different modules such as dropping sensor messages, modify pixel colors or LiDAR point clouds, or increasing latencies between modules, and verifying whether the autonomy is robust to such perturbations.

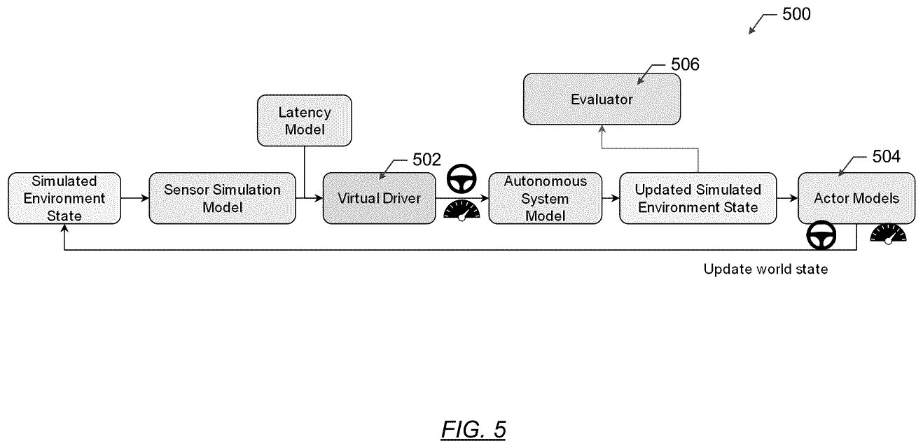

FIG. 5 shows an example of closed-loop evaluation mode (500). Open-loop evaluation replays the real world, but does not allow the autonomous system or the other actors in the scene to deviate from real-world trajectories. Closed loop evaluation mode handles what if scenarios, such as how the virtual driver would perform on a different platform, if an actor performed differently, or on a completely unseen scenario/map/actor behavior?” Specifically, in the closed loop evaluation mode (500) a simulated environment state is the three dimensional virtual environment in which the virtual driver is located. The sensor simulation model executes on the simulated environment state to generate realistic sensor inputs that would be detected by sensors located in the simulated environment on the autonomous system. Namely, the sensor simulation model takes, as input the simulated environment state and constructs the sensor inputs to the virtual driver. A latency model adds latency to the timing of the sensor inputs to reflect how the virtual driver receives and processes the sensor data in the real-world. The virtual driver outputs actuation actions to control the autonomous system. The actuation actions are passed to the autonomous system model which modifies the positioning of autonomous system in the simulated environment based on the actuation actions. For example, the autonomous system model may reflect an increase in speed, breaking, turning, or other action in the simulated environment. The actor models (504) also update according to the simulated environment state and the updated simulated environment state. Namely, the actor models react to the actions of the virtual driver. The evaluator can then evaluate the actions of the virtual driver.

As shown, In the closed loop evaluation mode, the virtual driver (502) and actor models (504) update their behavior at each time step given the current scene, and new sensor observations are simulated that reflect the scene. In the closed loop evaluation, the simulated environment state is updated based on both decisions by the virtual driver and the actor models. The result is a more realistic system performance testing as various components of the autonomous system, including localization and sensor perception, are testing. Accordingly, a change in the perception processing, a newly added sensor configuration, or compute platform change, may be evaluated whether the change improves the overall system performance as defined by the evaluator (506).

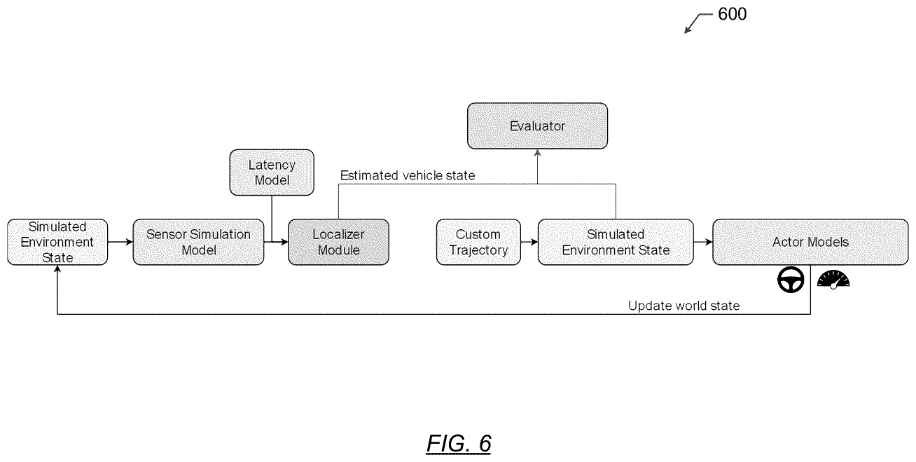

FIG. 6 shows an example of module level evaluation mode (600). The module level evaluation mode may be used to test a single module of the virtual driver in isolation. For example, the single module may be the localization module, motion planning, or controller module. One or more embodiments may configure the simulator to enable certain components and disable certain components to test only certain parts of virtual driver. For example, sensor simulation can execute at each time step solely to test the localizer performance and measure drift, or realistic perception and prediction outputs can be modeled solely to test the motion planner. These evaluations can be performed in either an open-loop or closed-loop setting depending on the configuration specified for the other simulation modules.

FIG. 6 shows an example of evaluating only the localization system in open-loop system. As shown, the localizer module of the virtual driver receives the sensor simulation model output along with the latency from the latency model. The output of the localizer is passed to the evaluator, which performs the evaluation. Separately, a predefined custom trajectory, which may or may not represent the real-world, is used as input to determine an updated simulated environment state. The actor models execute based on the simulated environment state and the updated simulated environment state, which is not affected by the localizer.

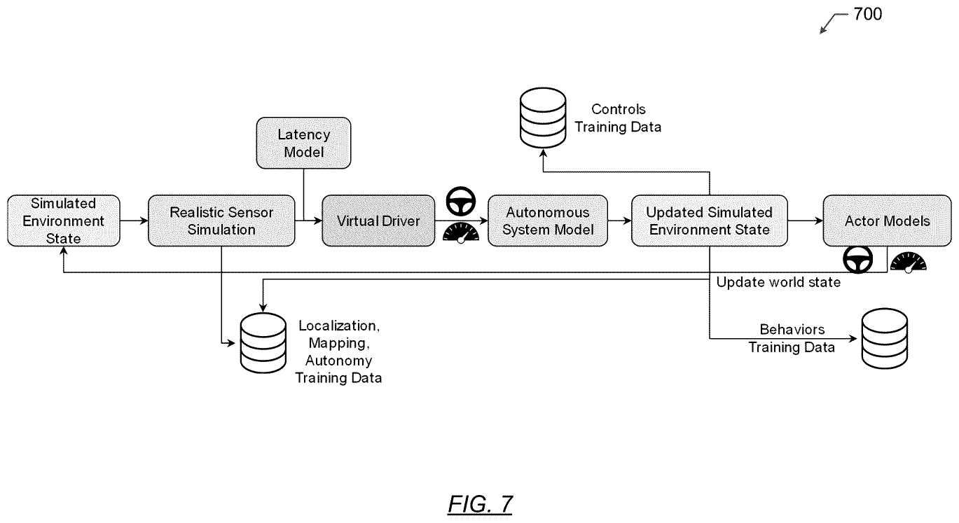

FIG. 7 shows an example of a training data generation mode (700). Rendering systems may be used to simulate sensor data offline to train perception models as part of training data generation. In the simulator, because assets can be built from real world data in addition to artist-derived CAD models, the assets have much more diversity to test many more scenario variations. Additionally, the customizable physics and neural rendering approach enables more realistic simulated sensor data. Along with generating training data for perception, the simulator can also generate training data for any of the simulation or autonomy modules, and even for offline calibration, mapping, and automatic labelling models. The training data generation improves the cost efficiency and development time of all components of autonomy and simulation.

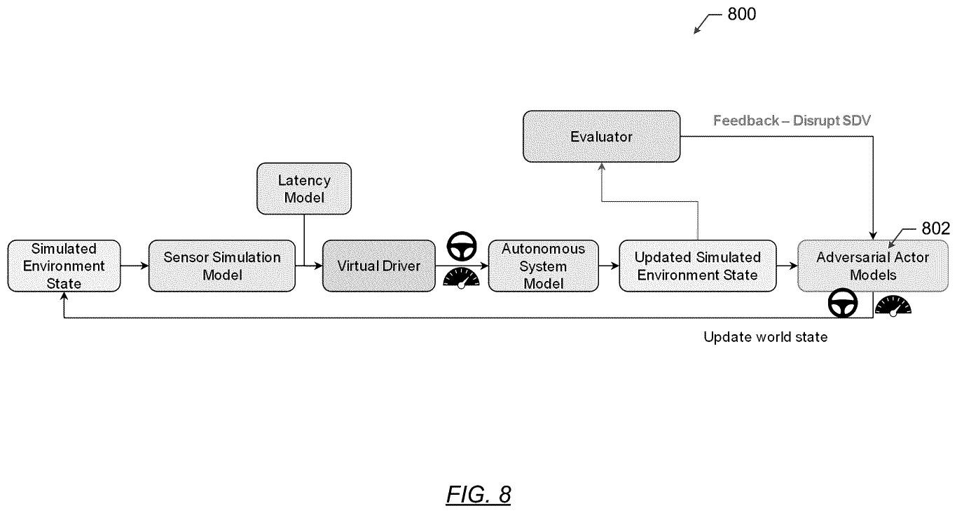

FIG. 8 shows an example of performing in adversarial mode (800). The simulator can execute a scenario defined by the simulation specification as described above with reference to FIG. 5. The evaluator evaluates the performance of the virtual driver against a variety of metrics. The output of the evaluator is passed to one or more adversarial actors (802). For example, in FIG. 8, the adversarial actor receives feedback that configures the adversarial model to disrupt the operation of the self-driving vehicle (SDV). Specifically, the output of the evaluator is matches the lowest performing the metric information of the virtual driver. For example, if the virtual driver did not perform well by causing a collision, the adversarial actor may be a car that cuts in front of the virtual driver. By using adversarial actors, simulation is performed to identify and execute the virtual driver on safety-critical scenarios on which the virtual driver may have difficulties. Thus, one or more embodiments address problems of using a virtual driver in the real-world in which there is a wide distribution of real world scenarios and long tails of rare events. Moreover, the end-to-end closed loop testing unlocks a new capability to instead automatically search and find challenging scenarios for the virtual driver, and also train or evaluate the virtual driver is on the most important scenarios that cover the real world distribution.

For example, given a simulation specification with optimizable parameters x (e.g., actor placement, actor behavior or route, weather conditions, etc.), the simulator acts as a black box function g, and virtual driver output maneuvers as a function of input sensor data as ƒ. The evaluator ε generates a score assessing the performance of the virtual driver in the simulated environment. The search for “adversarial” scenarios that are difficult for the virtual driver may be found using the following equation (Eq. 1):

$$arg {max}_{x} ℰ ( g ( x , f ) ) , s . t . ℛ ( g ( x , f ) ) \qquad Eq . 1$$

In equation Eq. 1, R sets constraints to ensure different samples of x lie in the feasible set of scenarios. Different optimization modules may be leveraged to identify adversarial scenarios, such as Bayesian Optimization or gradient estimation methodologies.

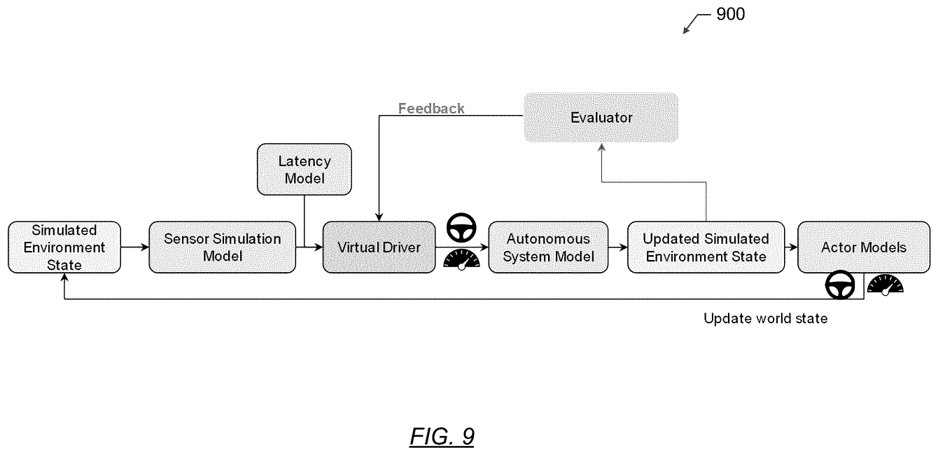

FIG. 9 shows an example of a closed loop training mode (900). Similar to adversarial scenario identification, the evaluator can be used to directly provide feedback to the virtual driver to learn from and improve the performance of the virtual driver within the simulator itself. The simulator uses the closed loop training for any traffic scenario including real world dense traffic domains. Closed-loop training can ensure the virtual driver and the various components thereof are optimized automatically for the end objective of driving performance.

Through a machine learning process, the overall system recognizes the causes of the failure, and the autonomous system learns how to avoid such failure in the future. Similarly, the evaluator may provide feedback on the areas in which the virtual driver may not have performed optimally.

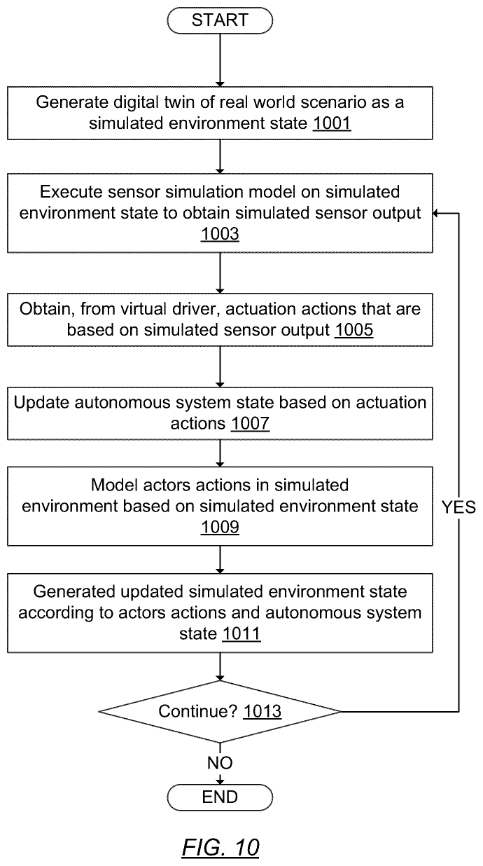

FIG. 10 shows a flow diagram for executing the simulator in a closed loop mode. In Block 1002, a digital twin of a real world scenario is generated as a simulated environment state. Log data from the real world is used to generate an initial virtual world. The log data defines which asset and actor models are used and an initial positioning of assets. For example, using convolutional neural networks on the log data, the various asset types within the real world may be identified. As other examples, offline perception systems and human annotations of log data may be used to identify asset types. Accordingly, corresponding asset and actor modes may be identified based on the asset types and add to the positions of the real actors and assets in the real world. Thus, the asset and actor models to create an initial three dimensional virtual world.

In Block 1003, the sensor simulation model is executed on the simulated environment state to obtain simulated sensor output. The sensor simulation model may use beamforming and other techniques to replicate the view to the sensors of the autonomous system. Each sensor of the autonomous system has a corresponding sensor simulation model and a corresponding system. The sensor simulation model executes based on the position of the sensor within the virtual environment and generates simulated sensor output. The simulated sensor output is in the same form as would be received from a real sensor by the virtual driver.

The simulated sensor output is passed to the virtual driver. In Block 1005, the virtual drive executes based on the simulated sensor output to generate actuation actions. The actuation actions defines how the virtual driver controls the autonomous system. For example, for an SDV, the actuation actions may be amount of acceleration, movement of the steering, triggering of a turn signal, etc. From the actuation actions, the autonomous system state in the simulated environment is updated in Block 1007. The actuation actions are used as input to the autonomous system model to determine the actual actions of the autonomous system. For example, the autonomous system model may use the actuation actions in addition to road and weather conditions to represent the resulting movement of the autonomous system. For example, in a wet or snow environment, the same amount of acceleration action as in a dry environment may cause less acceleration than in the dry environment. As another example, the autonomous system model may account for possibly faulty tires (e.g., tire slippage), mechanical based latency, or other possible imperfections in the autonomous system.

In Block 1009, actors' actions in the simulated environment are modeled based on the simulated environment state. Concurrently with the virtual driver model, the actor models and asset models are executed on the simulated environment state to determine an update for each of the assets and actors in the simulated environment. Here, the actor actions may use the previous output of the evaluator to test the virtual driver. For example, if the actor is adversarial, the evaluator may indicate based on the previous action of the virtual driver, the lowest scoring metric of the virtual driver. Using a mapping of metrics to actions of the actor model, the actor model executes to exploit or test that particular metric.

Thus, in Block 1011, the updated simulated environment state is updated according to the actor actions and the autonomous system state. The updated simulated environment includes the change in positions of the actors and the autonomous system. Because the models execute independently of the real world, the update may reflect a deviation from the real world. Thus, the autonomous system is tested with new scenarios. In Block 1013, a determination is made whether to continue. If the determination is made to continue, testing of the autonomous system continues using the updated simulated environment state in Block 1003. At each iteration, during training, the evaluator provides feedback to the virtual driver. Thus, the parameters of the virtual driver are updated to improve performance of the virtual driver in a variety of scenarios. During testing, the evaluator is able to test using a variety of scenarios and patterns including edge cases that may be safety critical. Thus, one or more embodiments improve the virtual driver and increase safety of the virtual driver in the real world.

As shown, the virtual driver of the autonomous system acts based on the scenario and the current learned parameters of the virtual driver. The simulator obtains the actions of the autonomous system and provides a reaction in the simulated environment to the virtual driver of the autonomous system. The evaluator evaluates the performance of the virtual driver and creates scenarios based on the performance. The process may continue as the autonomous system operates in the simulated environment.

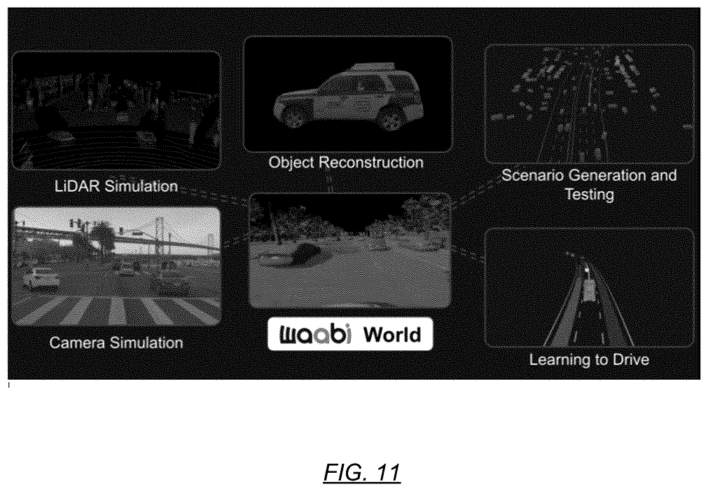

The virtual driver, evaluator, and other components and models of the system may be or include one or more machine learning models that are trained to perform operations. Example machine learning models that may be used include neural network models, decision trees, and other models. A goal is to teach the virtual driver of the autonomous system to drive intuitively, intelligently, and safely. As shown in FIG. 11, the simulator is a scalable, high fidelity closed-loop simulator as shown. Using artificial intelligence (AI), the simulated environment is an immersive and reactive environment that can design tests, assess skills, and teach the self-driving “brain” (i.e., the virtual driver) to learn to drive on its own. Using the simulated environment and the simulator, the virtual driver is exposed to the vast diversity of experiences needed to hone its driving skills, including both common driving scenarios and safety-critical edge cases. A goal is to reduce the need to drive testing miles in the real world and results in a safer, more affordable solution.

The simulator may have at least four core capabilities: (1) Builds digital twins of the world from data, automatically, semi-automatically, and at scale; (2) Performs near real-time high fidelity sensor simulation enabling testing of the entire software stack in an immersive and reactive manner; (3) Creates scenarios to stress-test the virtual driver, automatically and at scale; and (4) Teaches the virtual driver to learn from its mistakes and master the skills of driving without human intervention.

The simulator builds digital twins of the world from data, automatically and at scale. To be effective, a simulator needs to recreate the real world in high fidelity, in all its diversity and dynamism. The simulated environment leverages AI to reconstruct the geometry, appearance, and material properties of real-world objects and backgrounds from sensor data such as LiDAR returns and camera images. This enables the simulator to automatically recreate digital twins of the world from everywhere we drive, with the diversity, scale, and realism of the real world.

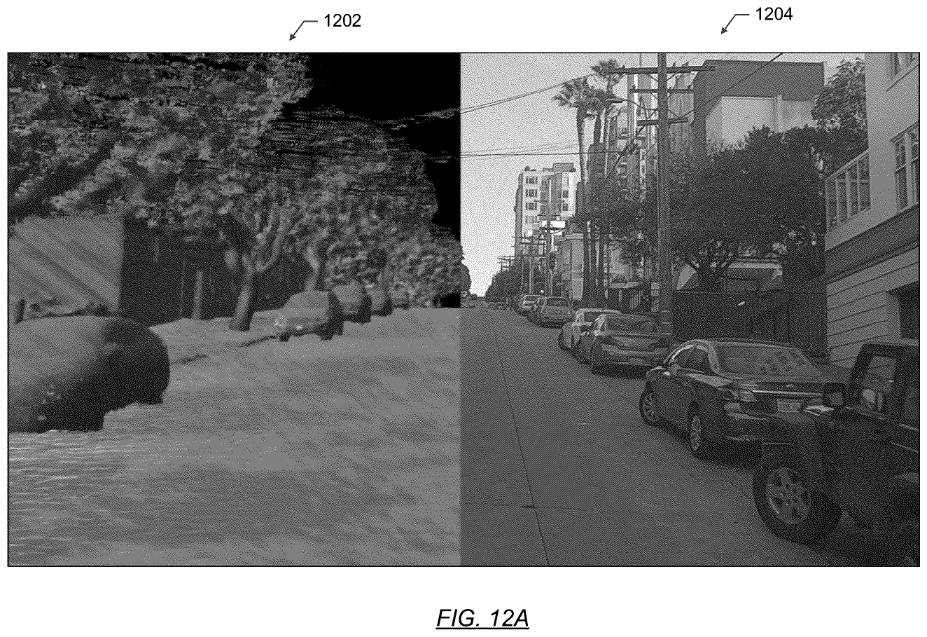

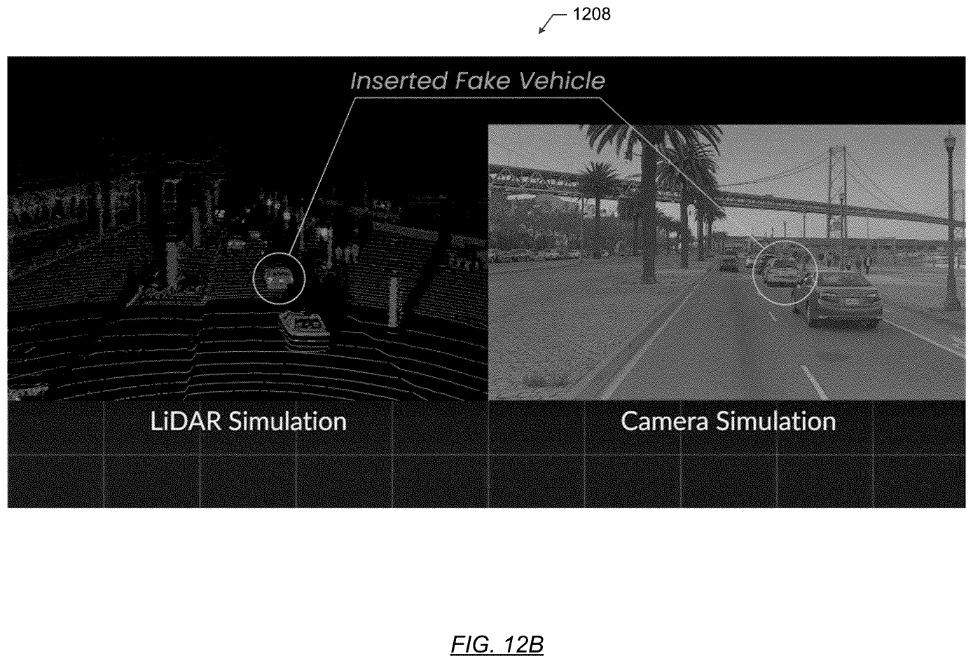

The simulator recreates reality as seen and uses AI to reconstruct a wide range of simulated objects and backgrounds. These objects and backgrounds can be used in the simulation system for creating new safety critical scenarios that test the autonomy system. Thus, the simulator uses simulation including LIDAR simulation, camera simulation, actor simulation, object reconstruction, and scenario generation and testing. For example, as shown in FIG. 12A, the left side (1202) of the street is a virtual world reconstruction of the same street as the right side (1204) of the street. In the simulated environment, the inputs to the virtual driver are designed to simulate the real world. The simulation may not be an accurate depiction of the state of the real world because the simulation may include a modification for a scenario. For example, as shown in FIG. 12B, a fake vehicle is added to the camera and LiDAR simulation (1208) that is used as input to the virtual driver. Further, as shown in FIG. 12B, the simulated environment is immersive to the virtual driver.

The simulator performs near real-time high fidelity sensor simulation enabling testing of the entire software stack in an immersive and reactive manner. Recreating the world exactly is a challenge. But for a simulator to truly replace driving in the real world, the simulator should behave the same in simulation as it would in the real world. The simulator achieves this by simulating how the virtual driver would observe or “see” the virtual world through its sensors, just like how it would see the real world. This is the only way to properly test the entire virtual driver in simulation and teach the virtual driver how to drive.

The simulator leverages AI along with simplified physics-based rendering to simulate realistic sensor data in near real-time. The AI algorithms, combined with high-quality recreated virtual worlds, learn to make the physics approximation look more realistic, while being computationally more efficient than traditional complex physics simulators.

With automatic generation of high-quality objects and virtual worlds, the simulator can not only recreate reality as seen, but also modify it by removing, adding, or changing the behavior of “actors” (e.g., other simulated objects) in scenarios and re-simulating the sensors. This enables the simulator to create an endless number of diverse worlds for the virtual driver to experience-unlocking the ability to realistically test the full software stack across interesting or safely-critical edge cases and help the virtual driver learn sophisticated driving skills.

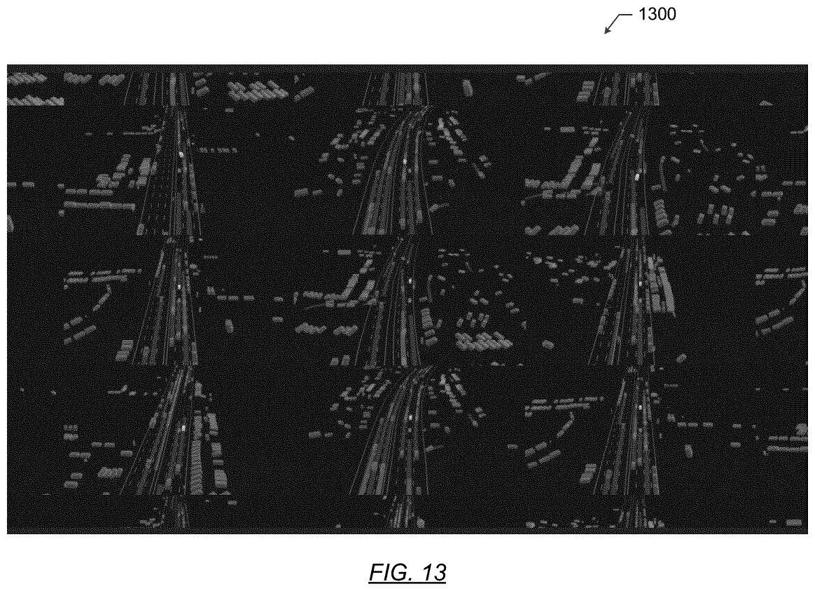

For example, the simulator may simulate a real scenario. The simulator then updates the scene with a new, fully simulated “actor” performing a given maneuver (e.g., a lane change (from left to right)) and generates the simulated sensor data. We can do this at scale, taking any existing scenario and modifying it to test the virtual driver. As shown in FIG. 13, multiple scenarios (1300) may be generated, and each scenario used to test and train the virtual driver.

The simulated environment can be employed to test different sensors and the sensors' configurations as well as vehicle platforms before the sensors and vehicles even exist. Using the simulator, new sensor configurations can be designed and validated rapidly as we can teach the virtual driver how to use them before they even exist in the real world, ultimately allowing for much faster development of self-driving vehicles and other autonomous systems.

Simulated environment creates scenarios automatically and stress-tests the virtual driver. The simulator uses AI to create traffic scenarios to test and train the virtual driver, generating all sorts of variations, with all sorts of traffic behavior, across all sorts of geographies, automatically and at scale.

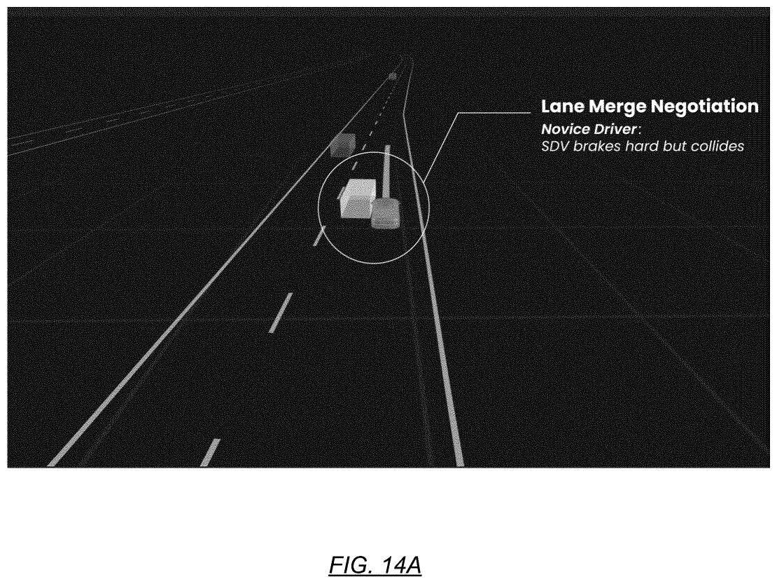

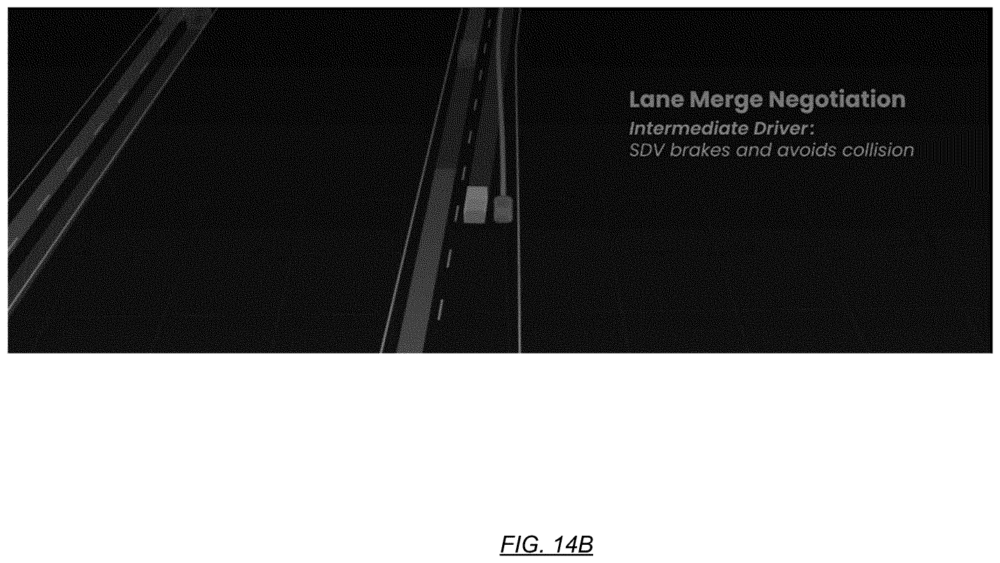

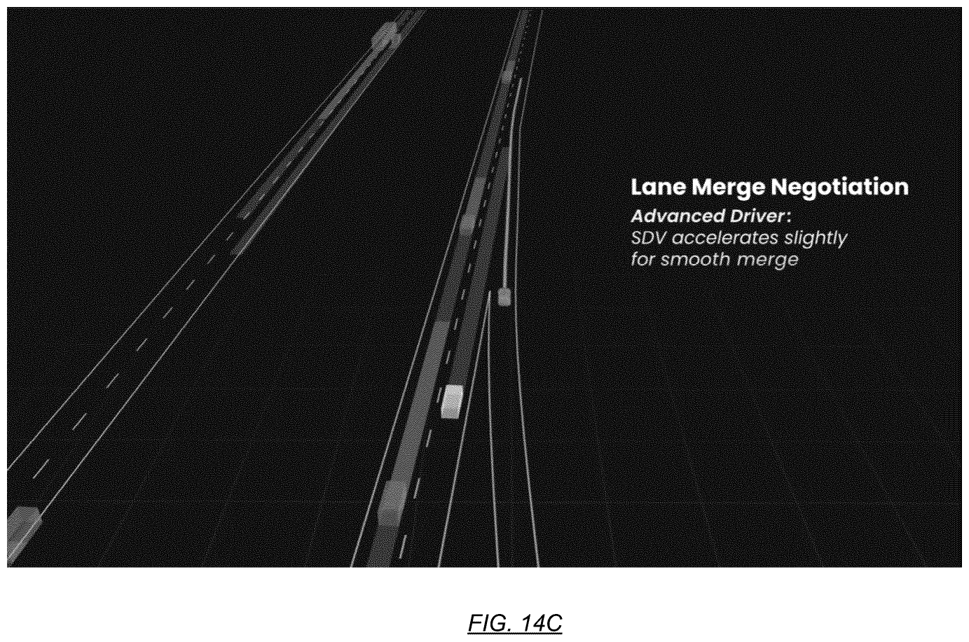

The scenarios are not static scenarios that simply play out like a movie. Driving is an interactive experience, and simulator replicates this interactive experience. The replication of the interactive experience is a closed-loop simulation as shown in FIG. 14. Every action of the virtual driver has a reaction in simulated environment. Specifically, the simulator causes the “actors” in the scenario to go and the operations to perform, the simulated sensors that see the updated simulated environment then tell the virtual driver what the virtual driver would observe, and then the virtual driver decides how it will react. The simulator then moves the virtual driver in the virtual world according to its decision, and the other traffic participants move accordingly. This loop goes on and on.

This type of simulation allows the virtual driver to truly experience how the scenario would play out if it were in the real world and the virtual driver was driving the self-driving vehicle. Thus, one or more embodiments enable accurate evaluation of the software stack's performance.

The simulator utilizes AI to pinpoint the virtual driver's weaknesses and automatically creates adversarial scenarios that our Driver will have difficulty handling. Namely, the simulator by way of the evaluator deliberately plays against the virtual driver, identifying and exploiting its weaknesses while the virtual driver simultaneously learns its skills. It's a battle of scenarios and driving skills-one AI system versus another (e.g., evaluator versus virtual driver).

It might seem counterintuitive, but the goal is to see the virtual driver fail. Failure of the virtual driver in the simulated environment reduces the possibility of failure in the real world. Thus, the simulator teaches the virtual driver to learn from its mistakes and master the skills of driving on its own.

Building a simulator that can recreate worlds, simulate sensor data, and generate infinite testing scenarios is all in service of one big, audacious objective: to teach the virtual driver to learn on its own to drive safely-in any vehicle, in any scenario, anywhere in the world.

For example, the virtual driver may initially have difficulty on a challenging lane-merge negotiation. Initially, the novice virtual driver collides with the other actor as shown in FIG. 14A. But through closed-loop training, the virtual driver can learn over time to get better. The intermediate virtual driver brakes and allows the other vehicle to pass as shown in FIG. 14B. After learning more in the simulated environment, the advanced virtual driver realizes the optimal maneuver is to smoothly accelerate slightly, preventing braking while also not causing difficulty for the other actor as shown in FIG. 14C. The evaluator provides feedback to the virtual driver.

The simulator exposes the virtual driver to the vast diversity of experiences needed to sharpen virtual driver's driving skills (including common driving scenarios and more elusive safety-critical edge cases). The simulator also delivers feedback to the virtual driver about the virtual driver's performance after each decision. The simulator's feedback system enables the AI to learn from its mistakes on its own in an immersive and reactive manner. The virtual driver is constantly, automatically learning from its actions to become a smarter driver over time.

In some cases, multiple clones of the virtual driver execute and are updated concurrently to learn to drive safely in different scenarios and in parallel with one another. Each clone has the same AI network that is updated based on each scenario. For example, the virtual driver could be learning how to drive down a quiet suburban street, on a 5-lane freeway, in the middle of the city during rush hour, and so on-all concurrently.

Through the simulator, the virtual driver is dropped into the Simulated environment and the virtual driver can see and behave as the virtual driver would in the real world. The simulator then creates traffic scenarios to test the virtual driver and generates variations of the scenarios that mimic calm afternoon, rush hour, etc. The simulator reacts in real time to virtual driver behavior to create interesting interactions. Every action has a reaction, the virtual driver makes a choice and traffic reacts. The virtual driver evolves through multiple scenarios, and evaluation of the virtual driver through the various scenarios. Thus, over time, the virtual driver may start as a novice driver and then learns how to drive safely.

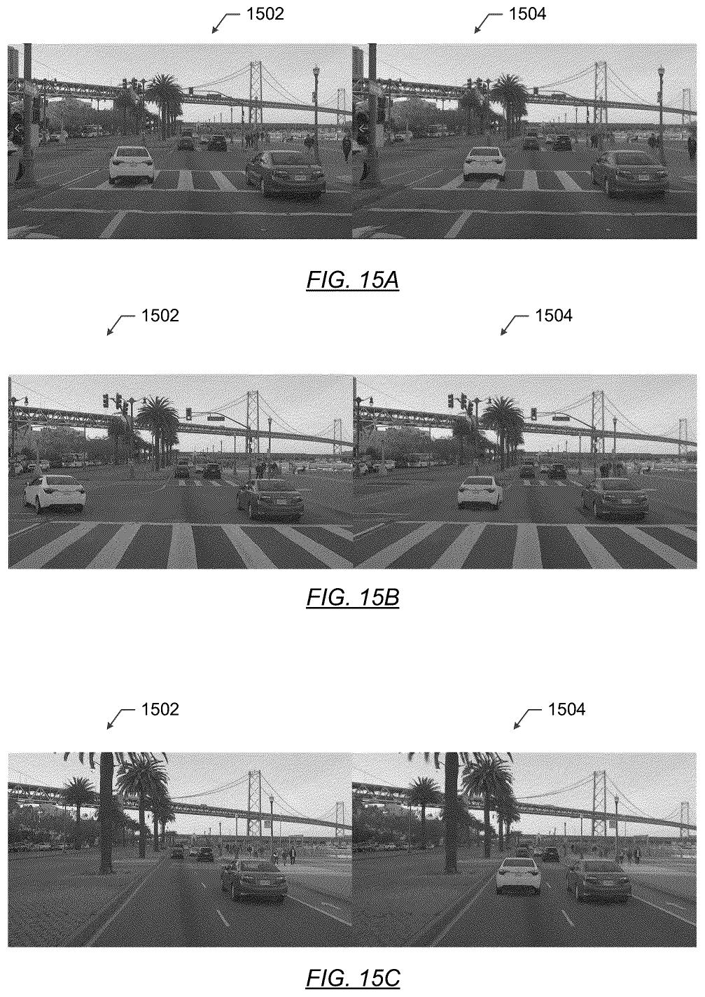

For example, as shown in FIG. 15A, FIG. 15B, and FIG. 15C, the simulator can create a mixed reality world in which actor actions deviate from the real world. The left image (1502) of FIG. 15A, FIG. 15B, and FIG. 15C show the real world images captured through an actual camera on the autonomous system. The right image (1504) of FIG. 15A, FIG. 15B, and FIG. 15C show the mixed reality image which deviates from the actual events. As shown based on a comparison of the left images with the right images, the car in front of the virtual driver makes a left hand turn in the real world while cuts in front of the virtual driver to continue straight in the simulated environment. As shown, through a single data capture of the real world, the simulator can create multiple scenarios (e.g., car makes left turn, car cuts into same lane as virtual driver) to fully test the virtual driver.

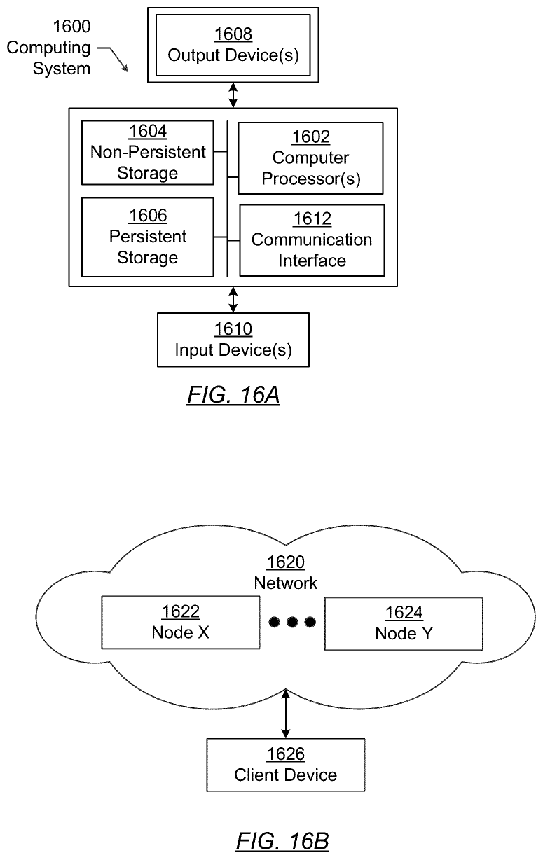

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 16A, the computing system (1600) may include one or more computer processors (1602), non-persistent storage (1604), persistent storage (1606), a communication interface (1608) (e.g., Bluetooth interface, infrared interface, network interface, optical interface, etc.), and numerous other elements and functionalities that implement the features and elements of the disclosure. The computer processor(s) (1602) may be an integrated circuit for processing instructions. The computer processor(s) may be one or more cores or micro-cores of a processor. The computer processor(s) (1602) includes one or more processors. The one or more processors may include a central processing unit (CPU), a graphics processing unit (GPU), tensor processing units (TPU), combinations thereof, etc.

The input devices (1610) may include a touchscreen, keyboard, mouse, microphone, touchpad, electronic pen, or any other type of input device. The input devices (1610) may receive inputs from a user that are responsive to data and messages presented by the output devices (1612). The inputs may include text input, audio input, video input, etc., which may be processed and transmitted by the computing system (1600) in accordance with the disclosure. The communication interface (1608) may include an integrated circuit for connecting the computing system (1600) to a network (not shown) (e.g., a local area network (LAN), a wide area network (WAN) such as the Internet, mobile network, or any other type of network) and/or to another device, such as another computing device.

Further, the output devices (1612) may include a display device, a printer, external storage, or any other output device. One or more of the output devices may be the same or different from the input device(s). The input and output device(s) may be locally or remotely connected to the computer processor(s) (1602). Many different types of computing systems exist, and the aforementioned input and output device(s) may take other forms. The output devices (1612) may display data and messages that are transmitted and received by the computing system (1600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (1600) in FIG. 16A may be connected to or be a part of a network. For example, as shown in FIG. 16B, the network (1620) may include multiple nodes (e.g., node X (1622), node Y (1624)). Each node may correspond to a computing system, such as the computing system shown in FIG. 16A, or a group of nodes combined may correspond to the computing system shown in FIG. 16A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (1600) may be located at a remote location and connected to the other elements over a network.

The nodes (e.g., node X (1622), node Y (1624)) in the network (1620) may be configured to provide services for a client device (1626), including receiving requests and transmitting responses to the client device (1626). For example, the nodes may be part of a cloud computing system. The client device (1626) may be a computing system, such as the computing system shown in FIG. 16A. Further, the client device (1626) may include and/or perform all or a portion of one or more embodiments.

The computing system of FIG. 16A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
generating a digital twin of a real world scenario as a simulated environment state of a simulated environment;
iteratively, through a plurality of timesteps:
executing a sensor simulation model on the simulated environment state to obtain simulated sensor output,
obtaining, from a virtual driver of an autonomous system, at least one actuation action that is based on the simulated sensor output,
updating an autonomous system state of the autonomous system based on the at least one actuation action,
modeling, using a plurality of actor models, a plurality of actors in the simulated environment according to the simulated environment state to obtain a plurality of actor actions, and
updating the simulated environment state according to the plurality of actor actions and the autonomous system state; and
evaluating the virtual driver after updating the simulated environment state.

2. The method of claim 1, further comprising:
wherein the simulated sensor output replicates a format of input to the virtual driver from a plurality of sensors on the autonomous system in the real world.

3. The method of claim 2, wherein the simulated sensor output comprises a LIDAR sensor output.

4. The method of claim 2, further comprising:
generating an image from a perspective of a camera of the autonomous system; and
presenting the image to the virtual driver.

5. The method of claim 1, further comprising:
adding a new actor to the plurality of actors to create a mixed reality scenario from the real world scenario; and
modeling, using an actor model of the new actor, a behavior of the new actor in the real world scenario,
wherein updating the simulated environment state accounts for the behavior of the new actor, and wherein the virtual driver reacts to the behavior of the new actor.

6. The method of claim 1, further comprising:
modifying, a behavior of an existing actor of the plurality of actors to create a mixed reality scenario from the real world scenario; and
modeling, using an actor model of the existing actor, the behavior of the existing actor in the real world scenario, wherein the updated autonomous system state accounts for the behavior of the existing actor,
wherein updating the simulated environment state accounts for the behavior of the existing actor, and wherein the virtual driver reacts to the behavior of the existing actor.

7. The method of claim 1, further comprising:
training the virtual driver to modify the virtual driver based on evaluating the virtual driver.

8. The method of claim 1, further comprising:
performing adversarial training of the virtual driver through modifying a behavior of the plurality of actors based on the evaluating the virtual driver.

9. The method of claim 1, further comprising:
modeling, using a latency model, a plurality of latencies of the virtual driver executing on the autonomous system in the real world scenario.

10. The method of claim 9, wherein the plurality of latencies comprises a sensor latency of transmitting sensor output to the virtual driver, a computer hardware latency of the virtual driver executing on the autonomous system, and an autonomous system latency of updating the autonomous system state based on the at least one actuation action.

11. A system comprising:
a virtual driver of an autonomous system; and
a computer processor executing a simulator causing the computer processor to perform operations comprising:
generating a digital twin of a real world scenario as a simulated environment state of a simulated environment;
iteratively, through a plurality of timesteps:
executing a sensor simulation model on the simulated environment state to obtain simulated sensor output,
obtaining, from the virtual driver of the autonomous system, at least one actuation action that is based on the simulated sensor output,
updating an autonomous system state of the autonomous system based on the at least one actuation action,
modeling, using a plurality of actor models, a plurality of actors in the simulated environment according to the simulated environment state to obtain a plurality of actor actions, and
updating the simulated environment state according to the plurality of actor actions and the autonomous system state; and
evaluating the virtual driver after updating the simulated environment state.

12. The system of claim 11, wherein the operations further comprise:
wherein the simulated sensor output replicates a format of input to the virtual driver from a plurality of sensors on the autonomous system in the real world.

13. The system of claim 11, wherein the operations further comprise:
adding a new actor to the plurality of actors to create a mixed reality scenario from the real world scenario; and
modeling, using an actor model of the new actor, a behavior of the new actor in the real world scenario,
wherein updating the simulated environment state accounts for the behavior of the new actor, and wherein the virtual driver reacts to the behavior of the new actor.

14. The system of claim 11, wherein the operations further comprise:
modifying, a behavior of an existing actor of the plurality of actors to create a mixed reality scenario from the real world scenario; and
modeling, using an actor model of the existing actor, the behavior of the existing actor in the real world scenario, wherein the updated autonomous system state accounts for the behavior of the existing actor,
wherein updating the simulated environment state accounts for the behavior of the existing actor, and wherein the virtual driver reacts to the behavior of the existing actor.

15. The system of claim 11, wherein the operations further comprise:
training the virtual driver to modify the virtual driver based on evaluating the virtual driver.

16. The system of claim 11, wherein the operations further comprise:
performing adversarial training of the virtual driver through modifying a behavior of the plurality of actors based on the evaluating the virtual driver.

17. The system of claim 11, wherein the operations further comprise:
modeling, using a latency model, a plurality of latencies of the virtual driver executing on the autonomous system in the real world scenario.

18. The system of claim 17, wherein the plurality of latencies comprises a sensor latency of transmitting sensor output to the virtual driver, a computer hardware latency of the virtual driver executing on the autonomous system, and an autonomous system latency of updating the autonomous system state based on the at least one actuation action.

19. A non-transitory computer readable medium comprising computer readable program code for causing a computer system to perform operations comprising:
generating a digital twin of a real world scenario as a simulated environment state of a simulated environment;
iteratively, through a plurality of timesteps:
executing a sensor simulation model on the simulated environment state to obtain simulated sensor output,
obtaining, from a virtual driver of an autonomous system, at least one actuation action that is based on the simulated sensor output,
updating an autonomous system state of the autonomous system based on the at least one actuation action,
modeling, using a plurality of actor models, a plurality of actors in the simulated environment according to the simulated environment state to obtain a plurality of actor actions, and
updating the simulated environment state according to the plurality of actor actions and the autonomous system state; and
evaluating the virtual driver after updating the simulated environment state.

20. The non-transitory computer readable medium of claim 19, further comprising:
adding a new actor to the plurality of actors to create a mixed reality scenario from the real world scenario; and
modeling, using an actor model of the new actor, a behavior of the new actor in the real world scenario,
wherein updating the simulated environment state accounts for the behavior of the new actor, and wherein the virtual driver reacts to the behavior of the new actor.
